(19) United States
(12) Patent Application Publication
(10) Pub. No.: US 2008/0199778 A1
(43) Pub. Date: Aug. 21, 2008

(54) Electrode for secondary batteries and method for making same, and secondary batteries using the electrode

(75) Inventors: Kazuki Hirata, Takahama-shi (JP); Kyohei Usami, Inazawa-shi (JP); Manabu Yamada, Okazaki-shi (JP)

Correspondence Address: HARNESS, DICKEY & PIERCE, P.L.C., P.O. BOX 828, BLOOMFIELD HILLS, MI, 48303, US

(73) Assignee: DENSO Corporation, Kariya-city (JP)

(21) Appl. No.: 12/070,538

(22) Filed: Feb. 19, 2008

(30) Foreign Application Priority Data
Feb. 20, 2007 (JP) 2007-039917
Dec. 27, 2007 (JP) 2007-336602

(51) Int. Cl. H01M 4/40; H01M 4/04

(52) U.S. Cl. 429/231.8; 429/231.95; 427/58

(57) ABSTRACT

An electrode for secondary batteries comprising a positive electrode, a negative electrode and a support electrolyte is used as at least one of the electrodes. The electrode comprises a radical compound and a single ion-conducting material. The single ion-conducting material has a functional group of —COOX or -S0₃X wherein X represents a Li or Na. A method for making such an electrode and a secondary battery comprising the electrode as at least one of a positive electrode and a negative electrode are provided.

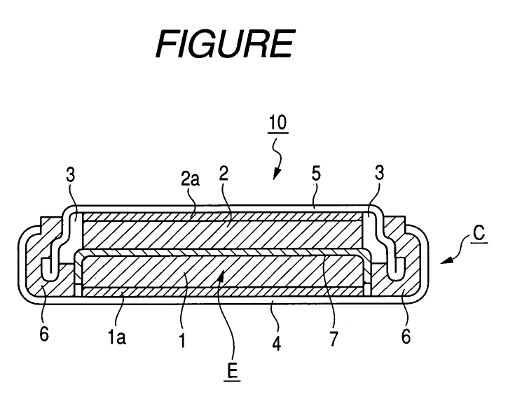

### CROSS-REFERENCE TO RELATED APPLICATION

This application is related to Japanese Patent Applications No. 2007-39917 filed on Feb. 20, 2007 and No. 2007-336602 filed on Dec. 27, 2007, the contents of which are hereby incorporated by reference.

### BACKGROUND OF THE INVENTION

1. Field of the Invention

This invention relates to an electrode useful for secondary batteries and a method for making the electrode and also to a secondary battery that makes use of the electrode and is thus excellent in large current charge and discharge characteristics and high in energy density.

2. Description of the Prior Art

Recently, a small-sized, large-capacity secondary battery having a high energy density has been highly demanded along with the spread of note-type personal computers and portable electronic devices such as digital cameras and the like. From the standpoint of environmental problems, electric vehicles and hybrid vehicles wherein electric power is utilized as part of drive power have been put to practice, for which a high performance of a secondary battery provided as a storage means of electric power has been demanded.

Development of lithium ion batteries has been in progress for a potential candidate of a secondary battery which meets the above demands. The development has been made so as to realize good stability and a high energy density.

However, the lithium ion battery involves intercalation and deintercalation of lithium ions upon charge and discharge, under which when a large electric current exceeding a certain level is passed, battery performance lowers. Accordingly, for the purpose of showing a high battery performance, limitation is necessary such that both charge and discharge rates do not exceed a given level, respectively.

Another type of secondary battery is known wherein a radical material, typical of which is poly(2,2,6,6-tetramethylpiperidinoxy methacrylate) (hereinafter abbreviated as PTMA), is used as a positive electrode. This secondary battery makes use of the adsorption and desorption reactions of ions for an ionization reaction, so that it is possible to allow passage of a current larger than in ordinary lithium ion batteries. In addition, this battery has good cycle characteristics and has been thus expected for application to portable electronic devices and electric motor vehicles.

It has been considered that in order to realize a high energy density in secondary batteries using a radical material such as PTMA as a positive electrode, it is necessary to increase an amount of radicals in the positive electrode and simultaneously permit a feed source of ions reacting with the radicals to be contained in an electrolytic solution in large amounts. For instance, the concentration of a support electrolyte in an electrolytic solution has been set at a high level depending on the capacity of a secondary battery.

If the concentration of a support electrolyte, typical of which is LiPF₆, is made high, the viscosity of the electrolytic solution increases, thereby lowering a diffusion speed of ions to lower the conductivity of the electrolytic solution. As a result, the value of an electric current taken out from the battery becomes small, thereby causing an output density to be lowered.

Furthermore, it has been confirmed that if a support electrolyte is added to an electrolytic solution in large amounts, wettability of the electrolytic solution to electrodes is worsened. This causes an internal resistance to be increased, resulting in the lowering of output power.

In other words, secondary batteries using radical materials involve a difficulty in achieving a good balance between the high energy density and high output density.

For a prior art technique concerning the high energy densification of secondary batteries using radical compounds, Japanese Laid-open Patent Application No. 2002-151084 proposes a technique wherein a radical compound is used as a positive electrode active material and limitation is placed on a spin concentration of the radical compound.

Japanese Laid-open Patent Application No. 2006-324179 proposes a technique wherein an anionic material having a phosphate, sulfonate, carboxylate or the like group is mixed in an electrode making use of a radical compound.

In the latter technique, however, when an organic solvent is used for preparing a paste obtained by mixing the materials, they cannot be dispersed satisfactorily. If water is provided as a liquid medium or solvent, the pH of the resulting paste becomes so small that a current collector foil made of aluminium undergoes corrosion. In either case, there is a high possibility that output power eventually lowers and such techniques have some room for improvement.

### SUMMARY OF THE INVENTION

It is accordingly an object of the invention to provide a secondary battery having a good balance between high energy density and high output density.

It is another object of the invention to provide an electrode adapted for use in such a secondary battery as mentioned above.

It is a further object of the invention to provide a method for making such an electrode as mentioned above.

As a result of intensive studies for the purposes of achieving the above objects, we have found that when a single ion-conducting material having a functional group of —COOX or —SO₃X, wherein X represents Li or Na, in the molecule is used as an electrode along with a radical compound, the characteristics of the radical compound can be satisfactorily shown. More particularly, the co-existence of a single ion-conducting material and a radical compound permits a high energy density to be realized even without addition of a high concentration of a support electrolyte in an electrolytic solution. Hence, according to one embodiment of the invention, there is provided an electrode for secondary batteries comprising a current collector and an electrode layer formed on at least one side of the current collector and made of a composition which comprises a radical compound, and a single ion-conducting material having a functional group of —COOX or —SO₃X wherein X represents Li or Na. The term “single ion-conducting material” used herein means a material of the type wherein only either an anion or a cation moves. This electrode for secondary batteries is preferably applied as a positive electrode although it may be used as a negative electrode or both electrodes.

As to a battery reaction in which a radical compound takes part, an instance of a reaction at a positive electrode is illustrated.

A radical moiety of a radical compound is oxidized into a cation during the course of charge and discharges electrons, thus taking part in the battery reaction. With the electrode for secondary batteries according to the invention, a cation dissociates from the single ion-conducting material to generate an anion and the charge of the cation generated from the radical compound is thus compensated, thereby permitting the battery reaction to be continued.

Accordingly, a smaller distance between the radical compound and the single ion-conducting material enables the reaction to more readily proceed. In this sense, it is preferred to use (a) a mixture of a radical compound and a single ion-conducting material or (b) a radical compound and a single ion-conducting material being chemically bonded together to form a kind of molecule thereof.

Preferably, the single ion-conducting material has a cationic moiety (Li⁺⁻ or Nap⁺) that is converted to a cation after dissociation and an anionic moiety (—COO⁻ or —SO₃⁻) that is a residue and generates an anion after dissociation of the cationic moiety.

Where the single ion-conducting material is not made of a polymer or is formed of a monomer, it has a group of —COOX or —SO₃X wherein X is Li or Na at a terminal end of the molecular structure. If the molecular weight per unit functional group is great, the amount of the single ion-conducting material has to be increased with a decrease in amount of the active material, thereby lowering the battery capacity. Accordingly, the molecular weight should preferably be as small as possible. Especially, it is preferred that the single ion-conducting material is made of a polymer wherein the molecular weight of a monomer unit thereof is at 300 or below. More preferably the molecular weight is at 200 or below.

Further, in order to avoid that the single ion-conducting material is lost from an electrode by dissolution in an electrolytic solution and not to increase the viscosity of the electrolytic solution by dissolution of the ion-conducting material in the electrolytic solution, it is preferred that the single ion-conducting material is substantially insoluble in the electrolytic solution.

The term “substantially insoluble in the electrolytic solution” used herein is intended to mean that when a single ion-conducting material is added to an ordinarily employed solution used, for example, in lithium batteries, an insoluble matter or precipitate is visually observed. Especially, when 0.1 M of a single ion-conducting material is added to a typical electrolytic solution made of ethylene carbonate and diethyl carbonate at a ratio of 3:7, the conductivity should preferably be not larger than 0.1 mS/cm. More preferably, the conductivity is at 0.01 mS/cm or below.

The single ion-conducting material should preferably have a polymer structure. This is because a higher molecular weight leads to more insolubility in an electrolytic solution. When the average molecular weight of the polymer structure is not smaller than 100,000, the insolubility in an electrolytic solution is significantly improved.

In order to quickly transfer electrons formed according to a battery reaction that proceeds in a radical compound, it is preferred (a) to formulate a conductive material mixed in a radical compound and a single ion-conducting material or (b) to use a radical compound and/or single ion-conducting material which has a conductive moiety in the molecular structure thereof.

For the manufacture of an electrode comprising a radical compound and a single ion-conducting material, importance is placed on uniform dispersion of the radical compound and the single ion-conducting material. Most of the single ion-conducting materials, which have a group of —COOX or -S0₃X wherein X has the same meaning as defined before, at a terminal end for monomers and at a terminal end and side chains for polymers, are soluble in water. For improving dispersability, water can be used as a solvent or liquid medium for the manufacture of the electrode.

According to another embodiment of the invention, there is provided a method for making an electrode for secondary batteries, which comprising dissolving and dispersing a radical compound and a single ion-conducting material in water to prepare a paste, applying the paste on at least one surface of a current collector, and drying the paste to form an electrode layer on the surface.

A secondary battery according to a further embodiment of the invention comprises a positive electrode, a negative electrode and a support electrolyte provided between the positive electrode and the negative electrode, wherein at least one of the electrodes consists of the electrode defined above.

### BRIEF DESCRIPTION OF THE ACCOMPANYING DRAWING

A sole FIGURE is a longitudinal sectional view schematically showing a structure of a coin battery according to the invention.

### EMBODIMENTS OF THE INVENTION

Embodiments of an electrode for secondary batteries and a second battery of the invention are described in more detail.

Initially, an electrode for secondary batteries according to the invention is described. The electrode comprises a current collector and an electrode layer formed on at least one surface of the current collector. The current collector may be made of those ordinarily used for this purpose including foils or meshes of metals such as nickel, aluminium, gold, silver, copper, stainless steels, aluminium alloys and the like.

The electrode layer formed on the surface of the current collector is made of a composition comprising a single ion-conducting material having a group of —COOX or —SO₃X wherein X represents Li or Na and a radical compound. This electrode may be used as at least one of positive and negative electrodes of a secondary battery.

The single ion-conducting material are those that have a cationic moiety capable of conversion to a cation after dissociation and an anionic moiety which is a residue after the dissociation of the cationic moiety and is capable of forming an anion after the dissociation. The single ion-conducting material used in the invention contributes to electric conduction through one kind of ion (i.e. a cation in this case). From the standpoint of the likelihood of association with and dissociation from a radical, organic acid salts are suitable for use as a single ion-conducting material.

The single ion-conducting materials useful in the invention include salts of organic acids having a functional group of —COOX or —SO₃X wherein X represents Li or Na. More particularly, the organic acid salts useful in the present invention can be represented by R—SO₃X and R—COOX. These organic acid salts exhibit a high dissociation of X, and the anion after the dissociation, i.e. R—SO₃⁻ or R—COO⁻, is likely to be chemically associated with and dissociated from a radical derived from a radical compound.

In the above formula, X is a cationic moiety or a group capable of forming a monovalent cation. As defined, X is Li or Na, of which Li with a smaller atomic weight is preferred.

In a single ion-conducting material wherein X is Li, the cation is lithium ion (Li⁺). After dissociation of the lithium, R—SO₃⁻ or R—COO⁻ is left as an anionic moiety, in which R represents, for example, an aromatic hydrocarbon residue such as a phenyl group, a styryl group or the like and an aliphatic hydrocarbon residue such as an unsubstituted or substituted, linear or branched alkyl or alkenyl group. Examples of the alkyl group include methyl, ethyl, propyl, butyl and the like and examples of the alkenyl group include vinyl, propenyl, butenyl, allyl and the like. Besides, R also represents a low molecular weight structure of organic matter and a high molecular weight or polymeric structure. The low molecular weight structure includes, for example, those of oligomers such as of aniline, thiophene, pyrrole, acetylene, acenes and the like. Examples of the polymeric structures include those of ordinary conductive polymers such as polyaniline, polypyrrole, polythiophene, polyacetylene, polyacenes and the like. These conductive polymers are preferred because of their electric conductivity and can be thus expected to show a function as a conductive material as well. These structures can be used as R in the single ion-conducting material.

It will be noted that a single ion-conducting material of the afore-indicated formula wherein R is H is not included within the scope of the invention.

Where R represents a high molecular weight chemical structure as mentioned above, such a structure may have a number of functional groups of —SO₃X or —COOX in the molecule. Moreover, R may include a moiety of a radical compound, for example, in such a way that a moiety of —SO₃X or —COOX that imparts single ion conductivity and a radical functional group (.e.g. a 2,2,6,6-tetramethylpiperidinoxy group) are bonded to a high molecular weight structure provided as a base material, thereby providing a high molecular weight material having both of the —SO₃X or —COOX and the radical functional group therein.

The single ion-conducting material is one which is able to realize ionic conduction by selective utilization of an anion and a cation and which is able to dissociate an ion corresponding to a radical compound in an environment where the electrode is applied to a secondary battery.

The single ion-conducting material contained in the electrode enables a battery reaction related to a radical compound to proceed smoothly. In addition, if a radical compound is contained in the electrode in amounts exceeding an amount of an anion that is a counter ion of Li ion contained in an electrolytic solution, e.g. PF₆⁻ when LiPF₆ is used as a support electrolyte, and the battery reaction continuedly proceeds, the amount of the counter ion or PF₆⁻ becomes insufficient for the reaction. The single ion-conducting material is able to cause the battery reaction of the radical compound to proceed in place of the counter ion or PF₆⁻. In this sense, it is preferred that the single ion-conducting material is contained in amounts corresponding to an amount of a radical compound existing in excess, which can be calculated by comparison between the number of radicals of the radical compound and the number of anions of a Li salt, such as LiPF₆, LiBF₄ or the like, in an electrolytic solution. For instance, the single ion-conducting material can be contained in amounts equal to or greater than an amount of an excess radical compound.

The content of the single ion-conducting material may be determined as set out above. It is preferred to determine the content of a singe ion-conducting material in such a way that a ratio between the number of radicals in a radical compound and the number of functional groups in a single ion-conducting material ranges from 1:0.1 to 3, more preferably 1:0.5 to 3.

The single ion-conducting material is preferably in the form of a solid in a secondary battery. Moreover, it is preferred that if a support electrolyte is used in the form of a liquid, the single ion-conducting material should not be dissolved in the solution. The single ion-conducting material can be prepared in the form of a liquid or solid or as being soluble or insoluble in liquid mediums by proper selection of the type of R and the molecular weight. It will be noted that no limitation is placed on the form of a single ion-conducting material prior to application of an electrode comprising an ion-conducting material to a secondary battery and prior to the manufacture of the electrode.

Although the single ion-conducting materials have been generically illustrated hereinabove, specific examples of the single ion-conducting material include lithium and sodium salts of aliphatic organic acids such as lithium acetate, sodium acetate, lithium butyrate, sodium butyrate, lithium acrylate, sodium acrylate, lithium maleate, sodium maleate and the like, lithium salts of aromatic organic acids such as lithium p-styrenesulfonate, sodium p-styrenesulfonate, lithium benzoate, sodium benzoate and the like, polymers of the above-indicated lithium and sodium salts of aliphatic and aromatic organic acids such as, for example, lithium polystyrenesulfonate, sodium polystyrenesulfonate, lithium polyacrylate, sodium polyacrylate, and the like. In addition, copolymers of lithium sulfonate or sodium sulfonate and a lithium or sodium salt of a carboxylic acid may also be used.

Of these, lithium polyacrylate is most preferred in view of the insolubility in an electrolytic solution containing organic solvents.

On the other hand, the radical compound used in combination with the single ion-conducting material is one that has a radical moiety in the molecular structure. Where the electrode of this embodiment is applied to a secondary cell, the oxidation and reduction of the radical in the molecular structure is in direct relation with the battery reaction. Accordingly, the type of radical compound should be appropriately selected depending on the type of secondary battery, to which the electrode of the invention is applied, i.e. the type of electrode to be used in combination, the type of support electrolyte and an intended battery performance.

The radical compounds, which are usable in application to secondary batteries using a lithium ion, includes nitroxyl radical compounds, oxy radical compounds, aryloxy radical compounds and compounds having an aminotriazine structure. Specific examples of these radical compounds are those set out in detail, for example, in Publication No. US2005/0170247. Of these, nitroxyl radical compounds are preferred including poly(2,2,6,6-tetramethylpiperidinoxy methacrylate)(PTMA), 2,2,5,5-tetramethyl-3-imidazolium-1-loxy acrylate and the like. Most preferably, poly(2,2,6,6-tetramethylpiperidinoxy methacrylate) is mentioned. In the practice of the invention, preferred combinations of a single ion-conducting material and a radical compound include combinations of lithium polyacrylate and nitroxyl radical compounds. More preferably, mention is made of a combination of lithium polyacrylate and poly(2,2,6,6-tetramethylpiperidinoxy methacrylate).

In the electrode, a single ion-conducting material and a radical compound should coexist as closely as possible. To this end, a radical compound and a single ion-conducting material are uniformly mixed preferably at a molecular level.

Alternatively, it is preferred to use a material wherein a radical compound and a single ion-conducting material are chemically bonded to form a molecule. For instance, a single ion-conducting material and a radical compound are simply bonded together. In addition, there may be mentioned those materials wherein a functional group of —SO₃X or —COOX of a single ion-conducting material and a radical functional group of a radical compound, e.g. a 2,2,6,6-tetramethylpiperidinoxy group, are chemically joined to a base polymer at side chains thereof.

For the purpose of causing electrons to be smoothly transferred from and to a radical compound, the electrode of the invention may further comprise a conductive material. The conductive material serves to improve electric conductivity between a radical compound and a current collector and should be dispersed in the electrode at a molecular level throughout the electrode. The conductive material is preferably used in an amount of 10 to 50 wt %, more preferably 10 to 35 wt % of the total of the radical compound, single ion-conducting material and conductive material.

Specific examples of the conductive material useful in the invention include ketchen black, acetylene black, carbon black, graphite, carbon nanotubes, amorphous carbon and the like, conductive polymers such as polyaniline, polypyrrole, polythiophene, polyacetylene, polyacenes and the like, and various types of metals.

The electrode of the invention may further comprises an active material other than the radical compound, which is related to the battery reaction (i.e. a compound capable of intercalation and deintercalation of a lithium ion).

The active material of the positive electrode useful in the invention includes, for example, lithium-metal composite oxides of a layer or spinel structure. Specific examples include Li₍₁₋ₓ₎NiO₂, Li₍₁₋ₓ₎MnO₂, Li₍₁₋ₓ₎Mn₂O₄, Li₍₁₋ₓ₎CoO₂, Li₍₁₋ₓ₎FeO₂ and the like wherein x in all the formulae is a value of o to 1. These oxides may be further replaced by or added with Li, Mg, Al or a transition metal such as Co, Ti, Nb, Cr or the like. In addition, these composite oxides may be used singly or in combination. Of these, at least one selected among lithium/manganese-containing composite oxides, lithium/nickel-containing composite oxides and lithium/cobalt-containing composite oxides of a layer or spinel structure are preferred.

The electrode of the invention may further comprise a binder for binding a single ion-conducting material, a radical compound and, if necessary, an active material therewith.

The binder is preferably formed of a polymer material. In view of the chemical and physical stabilities in an atmosphere inside the secondary battery, stable polymers such as polypropylene, polyethylene, polyimides, polyvinylidene fluoride, vinylidene fluoride-hexafluoropropylene copolymer, styrene-butadiene copolymer are preferred. If any one of a single ion-conducting material, radical compound, and conductive material is formed of a polymer material, such a material may also serve as a binder. In general, the binder is added to a mixture of a radical compound ad a single ion-conducting material in an amount of 3 to 10 wt % based on the total of the resulting composition.

In short, the electrode of the invention comprises, as essential elements, (a) a current collector formed such as of a metal foil and (b) a mixture of a radical compound and a single ion-conducting material. If necessary, an active material for positive electrode, a binder, a conductive material and other additive materials may be added to the radical compound and single ion-conducting material to provide an electrode composition. This composition is applied onto a current collector to provide an electrode of the invention. To make an electrode, the respective components are dispersed or dissolved in a dispersion medium, such as water, and applied to at least one surface of a current collector and dried to form an electrode layer on the current collector.

According to another embodiment of the invention, there is provided a secondary battery which comprises a negative electrode, a positive electrode and a support electrolyte interposed between the negative electrode and the positive electrode. In the practice of the invention, at least one of the electrodes is made of the electrode set forth hereinbefore, which comprises a radical compound and a single ion-conducting material. If the electrode of the invention is applied as a positive electrode of a secondary battery and the cation supplied from a single ion-conducting material is a lithium ion, an active material for the negative electrode is made of a compound that is able to occlude the lithium ion upon charge and release it upon discharge. The negative electrode active material may be those known in the art and includes, for example, a lithium metal, a carbon material such as graphite, amorphous carbon or the like, alloy materials containing silicon, tin and the like, oxide materials such as Li₄Ti₅O₁₂, Nb₂O₅ and the like. The negative electrode may be formed by a usual manner.

The support electrolyte is not critical in type. Although the secondary battery of the invention works in a solvent without use of any support electrolyte as will be particularly illustrated in examples, better discharge and charge characteristics are obtained if a support electrolyte is present in an electrolytic solution. The support electrolyte may be in the form of a solution dissolving a support electrolyte in an organic solvent, an ionic liquid of itself or an ionic liquid dissolving another type of support electrolyte therein. The organic solvents are those used in an electrolytic solution of an ordinary lithium secondary battery and include, for example, carbonates, halogenated hydrocarbons, ethers, ketones, nitrites, lactones, oxoranes and the like. Specific examples include propylene carbonate, ethylene carbonate, 1,2-dieethoxyethane, dimethyl carbonate, diethyl carbonate, ethylmethyl carbonate and mixtures thereof.

Among the exemplified organic solvents, a non-aqueous solvent selected from at least one selected from the carbonates and ethers is preferred because of their high solubility of a support electrolyte, excellent dielectric constant and viscosity, and good charge and discharge efficiencies of the battery.

The ionic liquid is not limited to any specific one so far as it is used in electrolytic solutions of ordinary lithium secondary batteries. For instance, mention is made of those having a cationic component of a highly conductive 1-methyl-3-ethyl imidazolium cation, a dimethylethylmethoxy ammonium cation and the like and an anionic component of BF₄⁻, N(S0₂C₂F₅)₂⁻ and the like.

The support electrolyte used in the invention includes, for example, LiPF₆, LiBF₄, LiCF₃SO₃, LiN(CF₃SO₂)₂, LiC(CF₃SO₂)₃, LiSbF₆, LiSiF₅, LiAlF₄, LiSCN, LiClO₄, LiCl, LiF, LiBr, LiI, LiAlF₄, LiAlCl₄, NaClO₄, NaClO₄, NaBF₄, NaI and the like. Of these, it is preferred from the standpoint of electric characteristics to use at least one of LiPF₆, LiBF₄, LiClO₄, LiCF₃SO₃, LiN(CF₃SO₂)₂ and LiC(CF₃SO₂)₂.

In the practice of the invention, it is preferred to interpose a separator between the positive electrode and the negative electrode for use as a member having both an electric insulation and an ion-conducting action. Where a support electrolyte is liquid, the separator serves to keep a liquid support electrolyte therein. The separator may be any ones ordinarily used for this purpose and is made, for example, of porous synthetic resin films, particularly, porous films or membranes made of polyolefin resins such as polyethylene, polypropylene and the like. For the purpose of ensuring insulation between the positive and negative electrodes, the separator should preferably have a size larger than the electrodes.

It is usual to accommodate a positive electrode, a negative electrode, a support electrolyte and a separator in a casing. The casing is not critical in type and may be made of a known material such a metal, a synthetic resin, a laminate film or the like and may take a cylindrical, coin or sheet shape.

Reference is now made to the sole figure, in which a typical secondary battery is schematically shown. In the figure, a coin battery 10 is shown as having a positive electrode 1 formed on a current collector 1a and a negative electrode 2 formed on a current collector 2a. Reference numeral 3 indicates an electrolytic solution and a separator 7 is provided between the positive electrode 1 and the negative electrode 2 to ensure electric insulation between the electrodes 1 and 2. The resulting element E is placed in a stainless steel casing C constituted of a positive electrode case 4 and a negative electrode case 5. The positive electrode case 4 and the negative electrode case 5 also serve as a positive electrode terminal and a negative electrode terminal, respectively. A gasket 6 made, for example, of polypropylene is interposed between the positive electrode case 4 and the negative electrode case 5 so that the cases 4, 5 are hermetically sealed and fully insulated from each other. If the electrode of the invention is applied as the positive electrode 1, the negative electrode 2 is made, for example, of lithium metal. The separator is made, for example, a porous film of polyethylene.

The coin battery is typical of a secondary battery to which the electrode of the invention is applicable. As mentioned before, the secondary battery may take any known form such as of a cylinder, sheet or the like.

Electrodes and secondary batteries using the same according to the invention are particularly described by way of examples. Comparative examples are also illustrated. It will be noted that the invention should not be construed as limited to those examples described hereinafter.

### EXAMPLE 1

Fabrication of a positive electrode for use as an electrode of a secondary battery:

Lithium p-styrenesulfonate used as a single ion-conducting material, PTMA used as a radical compound, carbon black used as a conductive material, sodium carboxymethyl cellulose (CMC-Na), polyoxyethylene oxide (PEO) and water used as a dispersion medium were mixed and dispersed at ratios by weight of 22:3:1:35:1:80 (parts by weight). Moreover, 1 part by weight of polytetrafluoroethylene (PTFE) were added to and dispersed in the resulting mixture to provide a positive electrode composition in the form of a slurry.

The thus obtained slurry was applied onto opposite sides of a current collector for positive electrode in the form of a thin aluminium foil, dried and pressed to obtain a positive electrode sheet. This positive electrode sheet was cut into a given size of a piece and the electrode composition at a portion to be welded with a lead tab for current terminal was removed to provide a sheet-shaped positive electrode. Preparation of an electrolytic solution:

A mixture of ethylene carbonate (EC) and diethyl carbonate (DEC) at a mixing ratio by weight of 3:7 was provided as an electrolytic solution as it is. It will be noted that in ordinary lithium secondary batteries, a support electrolyte such as LiPF₆ is dissolved in such a mixed solvent as mentioned above in most cases.

### Fabrication of a Three-electrode Cell:

For the purpose of evaluation of the positive electrode, a three-electrode cell was made. The positive electrode made above was provided as a positive electrode, a lithium metal was formed as a negative electrode, and a lithium metal was also provided as a reference electrode. The electrolytic solution prepared above was provided as an electrolytic solution. A separator was made of a 25 μm thick polyethylene porous film. The resulting three-electrode cell was subjected to evaluation of electrochemical characteristics according to cyclic voltanmetry in which the cell using the positive electrode as an acting electrode was subjected to cyclic voltanmetric measurement at a measuring potential ranging from 2.5V to 4.2 V based on Li, thereby evaluating a redox behavior of the positive electrode (i.e. the radical compound).

### Comparative Example 1

The general procedure of Example 1 was repeated except that no single ion-conducting material was added, thereby providing a positive electrode. More particularly, PTMA, carbon black, CMC, PEO and water were mixed and dispersed at ratios by weight (parts by weight) of 63:35:1:1:80. Next, 1 part by weight of PTFE was added to and dispersed in the resulting mixture to provide a positive electrode composition, from which a positive electrode was made. The positive electrode was used along with such a negative electrode and an electrolytic solution as used in Example 1 to provide a three-electrode cell.

### Comparative Example 2

### Preparation of an Electrolytic Solution:

A mixture of EC and DEC at a mixing ratio by weight of 3:7 was prepared, to which 0.1 mol/liter of LiPF₆ was added thereby obtaining an electrolytic solution. Using the same types of positive electrode and negative electrode as in Comparative Example 1 except for the electrolytic solution, a three-electrode cell was made.

### Comparative Example 3

### Preparation of an Electrolytic Solution:

A mixture of EC and DEC at a mixing ratio by weight of 3:7 was prepared, to which 0.1 mol/liter of LiPF₆ was added thereby obtaining an electrolytic solution. Using the same types of positive electrode and negative electrode as in Comparative Example 1 except for the electrolytic solution, a three-electrode cell was made.

### Evaluation:

The respective three-electrode cells of Example 1 and Comparative Examples 1 to 3 were subjected to electrochemical evaluation of a redox behavior of the radical compound. The results are shown in Table 1 below.

TABLE 1

| | Lithium p-styrenesulfonate | | LiPF₆ | |
|---|---|---|---|---|
| | In the | In the | In the | |
| | positive | electrolytic | electrolytic | Oxidation and |
| | electrode | solution | solution | reduction peaks |
| Example 1 | yes | no | no | 3.8 V, 3.6 V |
| Comparative | no | yes | no | no peak |
| Example 1 | | | | |
| Comparative | no | no | no | no peak |
| Example 2 | | | | |
| Comparative | no | no | yes | 3.8 V, 3.3 V |
| Example 3 | | | | |

As will be apparent from the table, it has been confirmed that when lithium p-styrenesulfonate serving as a single ion-conducting material is added to the positive electrode, the oxidation and reduction peaks of the radical appear like Comparative Example 3 where LiPF₆ is added to the electrolytic solution as corresponding to prior art. More particularly, when the single ion-conducting material is contained in the electrode, the cell reaction is allowed to proceed without dissolution of a support electrolyte in an electrolytic solution.

Because no redox reaction of the radicals proceeds not only in the three-electrode cell of Comparative Example 2 wherein no lithium p-styrenesulfonate is added, but also in the cell of Comparative Example 1 wherein no lithium p-styrenesulfonate is added to the positive electrode but added only to the electrolytic solution, it has been evidenced that the single ion-conducting material contributes to the redox reaction of the radicals only by coexisting in the positive electrode along with the radical compound.

This is considered as follows: the anionic group or anionic moiety after dissociation of lithium from the lithium p-styrenesulfonate, i.e. the p-styrenesulfonate anion, exists in the vicinity of the radical of the radical compound, thereby contributing to the redox reaction of the radical.

A similar test was conducted using lithium polyacrylate serving as a single ion-conducting material other than lithium p-styrenesulfonate, with the result that the addition of lithium polyacrylate to the positive electrode contributes to the progress of the redox reaction of the radical, like lithium p-styrenesulfonate.

### EXAMPLE 2

### Preparation of an Electrolytic Solution:

A mixture of EC and DEC at a mixing ratio by weight of 3:7 was provided, to which 0.6 mols/liter of LiPF₆ was added thereby obtaining an electrolytic solution.

Fabrication of a coin battery:

A coin battery of the type shown in the sole figure was made using the same types of positive and negative electrodes as in Example 1 except an electrolytic solution. More particularly, the positive electrode obtained in Example 1 was provided as a positive electrode 1, and lithium metal was used as a negative electrode 2. An electrolytic solution was such an electrolytic solution as prepared above. A separator 7 was formed using a 25 μm polyethylene porous film to provide a coin battery 10. The positive electrode 1 was formed on a current collector 1a and the negative electrode 2 was formed on a current collector 2a.

The resulting battery element E was accommodated in a stainless steel casing constituted of a positive electrode case 4 and a negative electrode case 5. As set out hereinbefore, the positive electrode case 4 and the negative electrode case 5 also served as a terminal for the positive electrode 1 and a terminal for the negative electrode 2, respectively. A polypropylene gasket was interposed between the positive electrode case 4 and the negative electrode case 5 to ensure hermetic sealing and electric insulation therebetween.

### EXAMPLE 3

### Preparation of an Electrolytic Solution:

A mixture of EC and DEC at a mixing ratio by weight of 3:7 was provided, to which 1.0 mol/liter of LiPF₆ was added thereby obtaining an electrolytic solution. The general procedure of Example 2 was repeated using the electrolytic solution prepared above, thereby providing a coin battery.

### EXAMPLE 4

Lithium polyacrylate used as a single ion-conducting material, PTMA used as a radical compound, carbon black used as a conductive material, CMC, PEO and water used as a dispersion medium were mixed and dispersed at mixing ratios by weight (parts by weight) of 15.5:47.5:35:1:1:80, to which 1 part by weight of PTFE was added as a binder, thereby obtaining a positive electrode composition in the form of a slurry. Using an electrolytic solution of the same type as in Example 2, a coin battery was made.

### EXAMPLE 5

### Preparation of an Electrolytic Solution:

ED and DEC were mixed at a ratio by weight of 3:7 to obtain a mixed solvent, to which 1.0 mol/liter of LiPF₆ was added to provide an electrolytic solution. This electrolytic solution and such positive and negative electrodes as used in Example 4 were used to make a coin battery.

### Comparative Example 4

The positive electrode, negative electrode and electrolytic solution made in Comparative Example 3 were used to obtain a coin battery.

### Evaluations:

The respective coin batteries obtained above were placed in a thermostatic chamber set at 25° C. and was subjected to constant current charge up to 4.1 V at a current value corresponding to 1C (i.e. 1C indicates a current value at which a battery capacity can be discharged in 1 hour) and subsequently to constant current discharge down to 3.0 V at a current value corresponding to 1C. This test was repeated five times, and the discharge capacity value at the fifth test was determined as a capacity value of the respective coin batteries.

Further, each battery was placed in a thermostatic chamber set at 25° C. and was subjected to constant current and constant voltage charge up to 4.1 V at a current value corresponding to 0.2 C and was discharged for 10 seconds by changing the current value. From the voltages after the 10 seconds discharge at the respective current values, an I-V curve was plotted to determine a current value at 3.0 V, thereby calculating an output power as a product of the current value and the voltage value (3.0 V).

The capacity ratio and output power ratio are, respectively, indicated as a ratio to the value of 1.0 of Comparative Example 4. The results are shown in Table 2.

TABLE 2

| | Concentration of | Capacity ratio | Output power ratio |
|---|---|---|---|
| | LiPF₆ (in | (based on | (based on |
| | electrolytic | Comparative | Comparative |
| | solution) | Example 4) | Example 4) |
| Example 2 | 0.6 mols/liter | 1.1 | 1.4 |
| Example 3 | 1.0 mol/liter | 1.3 | 1.9 |
| Example 4 | 0.6 mols/liter | 1.2 | 2.4 |
| Example 5 | 1.0 mol/liter | 1.4 | 3.2 |
| Comparative | 1.0 mol/liter | 1.0 | 1.0 |
| Example 4 | | | |

As will be apparent from Table 2, the batteries of Examples 2 to 5 are higher in capacity and output power than the battery of Comparative Example 4. More particularly, the addition of lithium p-styrenesulfonate and lithium polyacrylate ensures a capacity larger than the capacity of Comparative Example 4 although the concentration of the support electrolyte in the electrolytic solution is lower. In addition, when using an electrolytic solution having substantially the same concentration of support electrolyte as in Comparative Example 4, a higher capacity and a higher output power can be realized.

Further, the coin batteries of Examples 3 and 5 and Comparative Example 4 were each placed in a thermostatic chamber set at 25° C. and subjected to constant current and constant voltage charge up to 4.1 V at a current value corresponding to 0.2 C and then to constant current discharge down to 3.0 V at a current value corresponding to 10C, whereupon a capacity was measured.

The capacity ratio is indicated as a ratio to a capacity of Comparative Example 4 corresponding to 10C being taken at 1.0 The results are shown in Table 3.

TABLE 3

| | | Capacity ratio (based on |
|---|---|---|
| | Concentration of LiPF₆ (in | Comparative Example 4) |
| | electrolytic solution) | (corresponding to 10 C) |
| Example 3 | 1.0 mol/liter | 1.6 |
| Example 5 | 1.0 mol/liter | 2.1 |
| Comparative | 1.0 mol/liter | 1.0 |
| Example 4 | | |

As will be apparent from Table 3, even when the discharge current value is made higher, the addition of the single ion-conducting material to the positive electrode leads to a higher capacity than the case where no conducting material is added. In other words, a high capacity can be realized even when the concentration of a support electrolyte in the electrolytic solution is made low. Accordingly, where a high ion conductivity is necessary, the concentration of a support electrolyte in the electrolytic solution is made low and the ion conductivity is made high, with which a high capacity can be maintained.

The comparison between Examples 2, 3 wherein lithium p-styrenesulfonate was used as a single ion-conducting and Example 4, 5 wherein lithium polyacrylate was used reveals that the use of lithium polyacrylate leads to improvements in the capacity ratio and output power ratio. This is considered for the reason that since water is used as a liquid medium, the dispersability of the lithium polyacrylate and the radicals is improved.

### EXAMPLE 6

The general procedure of Example 2 was repeated except that lithium p-styrenesulfonate used as a single ion-conducting material was replaced by lithium benzoate, lithium poly-p-toluenesulfonate, lithium maleate, and styrene/maleic acid copolymer. The resulting batteries were evaluates in the same manner as in the foregoing examples, with similar results as in example 2 being obtained.

As will be apparent from the foregoing, the electrode of the invention ensures both a high output density and a high energy density. Especially, a high energy density can be realized in a condition where a concentration of a support electrolyte in an electrolytic solution is low. This suppresses viscosity rise of an electrolytic solution ascribed to dissolution of a support electrolyte at high concentration, resulting in a high output density.

What is claimed is:

1. An electrode for secondary batteries comprising a current collector and an electrode layer formed on at least one side of the current collector and made of a composition which comprises a radical compound, and a single ion-conducting material having a functional group of —COOX or —SO₃X wherein X represents Li or Na.

2. The electrode according to claim 1, wherein said radical compound and said single ion-conducting material coexist in the layer in a mixed form.

3. The electrode according to claim 1, wherein said radical compound and said single ion-conducting material are chemically bonded.

4. The electrode according to claim 1, wherein said single ion-conducting material has a cationic moiety of Li⁺ or Na⁺ and an anionic moiety of —COO⁻ or —SO₃⁻.

5. The electrode according to claim 4, wherein said cationic moiety consists of Li⁺.

6. The electrode according to claim 1, wherein said single ion-conducting material consists essentially of a monomeric compound which has the functional group and a molecular weight of not larger than 300.

7. The electrode according to claim 1, wherein said single ion-conducting material consists essentially of a polymer which has the functional group and a molecular weight of not smaller than 100,000.

8. The electrode according to claim 1, wherein said single ion-conducting material is substantially insoluble in a solvent used in an electrolytic solution of a secondary battery.

9. The electrode according to claim 1, further comprising a conductive material.

10. The electrode according to claim 1, wherein at least one of said radical compound and said single ion-conducting material has an electrically conductive moiety in the molecule.

11. The electrode according to claim 1, wherein said radical compound consists of a nitroxyl radical compound and said single ion-conducting material is a member selected from lithium polyacrylate, lithium poly-p-styrenesulfonate and a mixture thereof.

12. The electrode according to claim 11, wherein said nitroxyl radical compound consists of poly(2,2,6,6-tetramethylpiperidinoxy methacrylate) and said single ion-conducting material consists of lithium polyacrylate.

13. A method for making an electrode for secondary batteries comprising dissolving and dispersing a radical compound and a single ion-conducting material in water to prepare a paste, applying the paste on at least one surface of a current collector, and drying the paste to form an electrode layer on the surface.

14. A secondary battery comprising the electrode defined in claim 1 as at least one of a positive electrode and a negative electrode of said secondary battery.
